(19) United States
(12) Patent Application Publication
(10) Pub. No.: US 2023/0289568 A1
(43) Pub. Date: Sep. 14, 2023

(54) PROVIDING AN ALARM RELATING TO AN ACCURACY OF A TRAINED FUNCTION METHOD AND SYSTEM

(71) Applicant: SIEMENS AKTIENGESELLSCHAFT, München (DE)

(72) Inventors: Roman Eichler, Nürnberg (DE); Vladimir Lavrik, Dreieich (DE)

(21) Appl. No.: 18/013,893

(22) PCT Filed: Jun. 30, 2021
(86) PCT No.: PCT/EP2021/067965

§ 371 Date: Dec. 29, 2022

(30) Foreign Application Priority Data
Jun. 30, 2020 (EP) 20183025.4

(51) Int. Cl. G06N 3/0464; G06N 3/084

(52) U.S. Cl. CPC G06N 3/0464; G06N 3/084

(57) ABSTRACT

For improved provision of an alarm relating to an accuracy of a trained function, such as detecting an accuracy decrease of a trained function under a distribution drift of incoming data, the following computer-implemented method is suggested: receiving input data messages (140) relating to at least one variable of at least one device (142); applying a trained function (120) to the input data messages (140) to generate output data (152), the output data (152) being suitable for analyzing, monitoring, operating and/or controlling the respective device (142); determining at least one respective distance of the respective variable of a respective received input data message (140) to a reference data set, determining an accuracy value of the trained function (120) using the respective distance and a regression model (130); and if the determined accuracy value is smaller than an accuracy threshold: providing an alarm (150) relating to the determined accuracy value to a user, to the respective device (142) and/or an IT system connected to the respective device (142).

### TECHNICAL FIELD

The present disclosure is directed, in general, to software management systems, in particular systems for providing an alarm relating to an accuracy of a trained function, such as detecting an accuracy decrease of a trained function under a distribution drift of incoming data (collectively referred to herein as product systems).

### BACKGROUND

Recently, an increasing number of computer software products involving artificial intelligence, machine learning, etc. is used for performing various tasks. Such computer software products may, for example, serve for purposes of voice, image or pattern recognition. Furthermore, such computer software products may directly or indirectly—e.g., by embedding them in more complex computer software products—serve to analyze, monitor, operate and/or control a device, e.g., in an industrial environment. The present invention generally relates to computer software products providing an alarm and to the management and, e.g., the update of such computer software products.

Currently, there exist product systems and solutions which support analyzing, monitoring, operating and/or controlling a device using a trained function and which and which support management of such computer software products involving a trained function. Such product systems may benefit from improvements.

### SUMMARY

Variously disclosed embodiments comprise methods and computer systems that may be used to facilitate providing an alarm relating to an accuracy of a trained function and managing computer software products.

According to a first aspect of the invention, a computer-implemented method may comprise:
receiving input data messages relating to at least one variable of at least one device;
applying a trained function to the input data to generate output data, the output data being suitable for analyzing, monitoring, operating and/or controlling the respective device;
determining at least one respective distance of the respective variable of a respective received input data message to a reference data set,
determining an accuracy value of the trained function using the respective distance and a regression model (130); and
if the determined accuracy value is smaller than an accuracy threshold:
providing an alarm relating to the determined accuracy value to a user, to the respective device and/or an IT system connected to the respective device.

By way of example, the input data may be received with a first interface. Further, the regression model may be applied to the input data with a computation unit. In some examples, the alarm relating to the determined accuracy value may be provided with a second interface.

According to a second aspect of the invention, a system, e.g., a computer system or IT system, may be arranged and configured to execute the steps of this computer-implemented method. In particular, the system may comprise:
a first interface, configured for receiving input data messages relating to at least one variable of at least one device;
a computation unit, configured for
   applying a trained function to the input data messages to generate output data, the output data being suitable for analyzing, monitoring, operating and/or controlling the respective device;
   determining at least one respective distance of the respective variable of a respective received input data message to a reference data set,
   determining an accuracy value of the trained function using the respective distance and a regression model; and
a second interface, configured for providing an alarm relating to the determined accuracy value to a user, to the respective device and/or an IT system connected to the respective device, if the determined accuracy value is smaller than an accuracy threshold.

According to a third aspect of the invention, a computer program product may comprise computer program code which, when executed by a system, e.g., an IT system, cause the system to carry out the described method of providing an alarm relating to an accuracy of a trained function.

According to a fourth aspect of the invention, a computer-readable medium may comprise computer program code which, when executed by a system, e.g., an IT system, cause the system to carry out the described method of providing an alarm relating to an accuracy of a trained function. By way of example, the described computer-readable medium may be non-transitory and may further be a software component on a storage device.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the detailed description below, it should be understood that various definitions for certain words and phrases are provided throughout this patent document and those of ordinary skill in the art will understand that such definitions apply in many, if not most, instances to prior as well as future uses of such defined words and phrases. While some terms may comprise a wide variety of embodiments, the appended claims may expressly limit these terms to specific embodiments.

### BRIEF DESCRIPTION OF THE DRAWINGS

FIG. 1 illustrates a functional block diagram of an example system that facilitates providing an alarm in a product system.

FIG. 2 illustrates a degradation of a trained model in time due to a data distribution shift.

FIG. 3 illustrates a flow diagram of an example methodology that facilitates providing an alarm in a product system.

FIG. 4 illustrates a functional block diagram of an example system that facilitates providing an alarm and managing computer software products in a product system.

FIG. 5 illustrates another flow diagram of an example methodology that facilitates providing an alarm in a product system.

FIG. 6 illustrates an embodiment of an artificial neural network.

FIG. 7 illustrate an embodiment of a convolutional neural network.

FIG. 8 illustrates a block diagram of a data processing system in which an embodiment can be implemented.

### DETAILED DESCRIPTION

Various technologies that pertain to systems and methods for providing an alarm and for managing computer software products in a product system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present patent document will be described with reference to exemplary non-limiting embodiments.

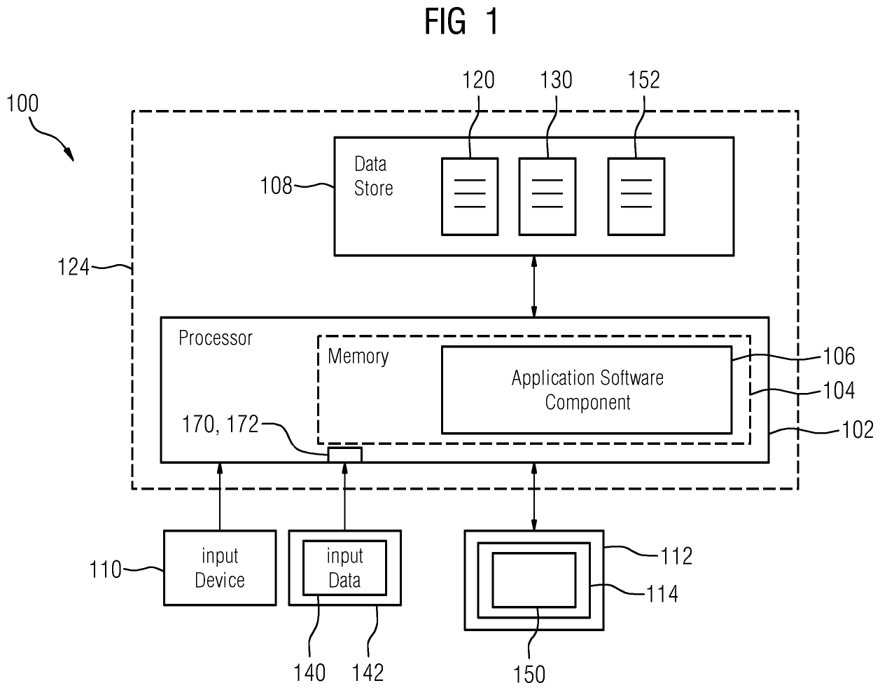

With reference to FIG. 1, an example computer system or data processing system 100 is illustrated that facilitates providing an alarm 150, in particular providing an alarm 150 relating to an accuracy of a trained function 120, e.g., involving detecting an accuracy decrease of a trained function 120 under a distribution drift of incoming data. The processing system 100 may comprise at least one processor 102 that is configured to execute at least one application software component 106 from a memory 104 accessed by the processor 102. The application software component 106 may be configured (i.e., programmed) to cause the processor 102 to carry out various acts and functions described herein. For example, the described application software component 106 may comprise and/or correspond to one or more components of an application that is configured to provide and store output data in a data store 108 such as a database.

It should be appreciated that it can be difficult and time-consuming to provide an alarm 150 in complex application and industrial environments. For example, advanced coding knowledge of users or IT experts may be required, or selections of many options need to be made consciously, both involving many manual steps, which is a long and not efficient process.

To enable the enhanced provision of an alarm 150, the described product system or processing system 100 may comprise at least one input device 110 and optionally at least one display device 112 (such as a display screen). The described processor 102 may be configured to generate a GUI 114 through the display device 112. Such a GUI 114 may comprise GUI elements such as buttons, text boxes, images, scroll bars) usable by a user to provide inputs through the input device 110 that may support providing the alarm 150.

In an example embodiment, the application software component 106 and/or the processor 102 may be configured to receive input data messages 140 relating to at least one variable of at least one device 142. Further, the application software component 106 and/or the processor 102 may be configured to apply a trained function 120 to the input data messages 140 to generate output data, the output data 152 being suitable for analyzing, monitoring, operating and/or controlling the respective device 142. In some examples, the application software component 106 and/or the processor 102 may further be configured to determine at least one respective distance of the respective variable of a respective received input data message 140 to a reference data set and to determine an accuracy value of the trained function 120 using the respective distance and a regression model 130. The application software component 106 and/or the processor 102 may further be configured to provide an alarm 150 relating to the determined accuracy value to a user, to the respective device 142 and/or an IT system connected to the respective device 142, if the determined accuracy value is smaller than an accuracy threshold.

In some examples, the trained function 120, the regression model 130, and/or the reference data set are provided beforehand and stored in the data store 108.

The input device 110 and the display device 112 of the processing system 100 may be considered optional. In other words, the sub-system or computation unit 124 comprised in the processing system 100 may correspond to the claimed system, e.g., IT system, which may comprise one or more suitably configured processor(s) and memory.

By way of example, the input data messages 140 may be an incoming stream of data messages. The data messages may, e.g., comprise measured sensor data, wherein the at least one variable may be a temperature, a pressure, an electric current, and electric voltage, a distance, a speed or velocity, an acceleration, a flow rate, electromagnetic radiation comprising visible light, or any other physical quantity. In some examples, the respective variable may also relate to chemical quantities, such as acidity, a concentration of forgiven substance in the mixture of substances, and so on. The respective variable may, e.g., characterize the respective device 142 or the status in which the respective device 142 is. In some examples, the respective variable may characterize a machining or production step which is carried out or monitored by the respective device 142.

The respective device 142 may, in some examples, may be or comprise a sensor, an actuator, such as an electric motor, a valve or a robot, and inverter supplying an electric motor, a gear box, a programmable logic controller (PLC), a communication gateway, and/or other parts component relating to industrial automation products and industrial automation in general. The respective device 142 may be part of a complex production line or production plant, e.g., a bottle filing machine, conveyor, welding machine, welding robot, etc. In further examples, there may be input data messages 142 relating to one or more variables of a plurality of such devices 142.

Further, by way of example, the IT system may be or comprise a manufacturing operation management (MOM) system, a manufacturing execution system (MES), and enterprise resource planning (ERP) system, a supervisory control and data acquisition (SCADA) system, or any combination thereof.

The input data messages 140 may be used to generate output data 152 by applying a trained function 120 to the input data messages 140. The trained function 120 may, e.g., correlate the input data messages or the respective variable to the output data 152. The output data 152 may be used to analyze or monitor the respective device 142, e.g., to indicate whether the respective device 142 is working properly or the respective device 142 is monitoring a production step which is working properly. In some examples, the output data 152 may indicate that the respective device 142 is damaged or that there may be problems with the production step which is monitored by the respective device 142. In other examples, the output data 152 may be used to operate or control the respective device 142, e.g., implementing a feedback loop or a control loop using the input data messages 140, analyzing the input data messages 140 by applying the trained function 120, and controlling or operating the respective device 142 based on the received input data messages 140. In some examples, the device 142 may be a valve in a process automation plant, wherein the input data messages comprise data on a flow rate as a physical variable, the flow rate then being analyzed with the trained function 120 to generate the output data 152, wherein the output data 152 comprises one or more target parameters for the operation of the valve, e.g., a target flow rate or target position of the valve.

In some examples, the reference data set may correspond to a training data set. A reference data set may be provided beforehand, e.g., by identifying typical scenarios and the related to typical variables or input data messages 140. Such typical scenarios may, e.g., a scenario when the respective device 142 is working properly, when the respective device 142 monitors a properly executed production step, when the respective device 142 is damaged, when the respective device 142 monitors an improperly executed production step, and so on. By way of example, the device 142 may be a bearing which is getting too hot during its operation and hence has increased friction. Such scenarios can be analyzed or recorded beforehand so that corresponding reference data may be provided. When corresponding input data messages 140 are received, these input data messages 140 may be compared with the reference data set to determine the respective distance of the respective irreparable to the reference data. In some examples, the distance may be a multi-dimensional distance, e.g., if the respective variable(s), the respective reference data set and/or the trained function is. By way of example, the incoming data messages 140 comprise data on n variables, with n>1 and the trained function reflects m different scenarios, with m>1, e.g., one acceptable status scenario and m−1 different damage scenarios. Then the distance may be a n×m distance matrix or distance vector having n rows and m columns.

The calculated distance may then be used to determine accuracy value of the trained function 120, wherein a regression model 130 may be used. The regression model 130 may, e.g., link a respective distance with a corresponding accuracy value. In some examples, the regression model may be a table linking the respective distance with the corresponding accuracy value, in other examples the regression model may be a more complex function, e.g., a trained function, as explained below.

Then, if the determined accuracy value is smaller than an accuracy threshold, along 150 may be provided to a user, to the respective device 142 and/or to an IT system connected to the respective device 142. In some examples, the threshold may be provided before and be fixed, e.g., to 95% or 98%. The alarm 150 relating to the determined accuracy value may be provided to a user, e.g., monitoring or supervising a production process involving the device 142 so that he or she can trigger further analysis of the device 142 or the related production step. In some examples, the alarm 150 may be provided to the respective device 142 or to the IT system, e.g., and scenarios in which the respective device or the IT system may be or comprise a SCADA, MOM or MES system.

It should further be appreciated that the determined accuracy value of the trained function 120 may be interpreted in terms of trustworthiness of the trained function 120. In other words, the determined accuracy value may indicate whether the trained function 120 is trustworthy or not. By way of example, the generated alarm 150 may comprise the accuracy value or an information on the (level of) trustworthiness of the trained function 120.

Further, in some examples, outliers with respect to the input data messages 140 may be allowed so that not each and every input data messages 140 may trigger an alarm 150. E.g., the alarm 150 may only be provided if the determined accuracy value is smaller than the accuracy threshold for a given number z of sequentially incoming input data messages 140.

As already mentioned above, the system 100 illustrated in FIG. 1 may correspond or comprise the computation unit 124. Further, it may comprise a first interface 170 for receiving input data messages 140 relating to at least one variable of the at least one device 142 and a second interface 172, for providing an alarm 150 relating to the determined accuracy value to a user, to the respective device 142 and/or an IT system connected to the respective device 142, if the determined accuracy value is smaller than an accuracy threshold. Depending on to which device or system the alarm 150 is sent, the first interface 170 and the second interface 172 may be the same interface all different interfaces. In some examples, the first interface 170 and/or the second interface 172 may be comprised by the computation unit 124.

In some examples, the input data messages 140 undergo a distribution drift involving a decrease of the accuracy value of the trained function 120.

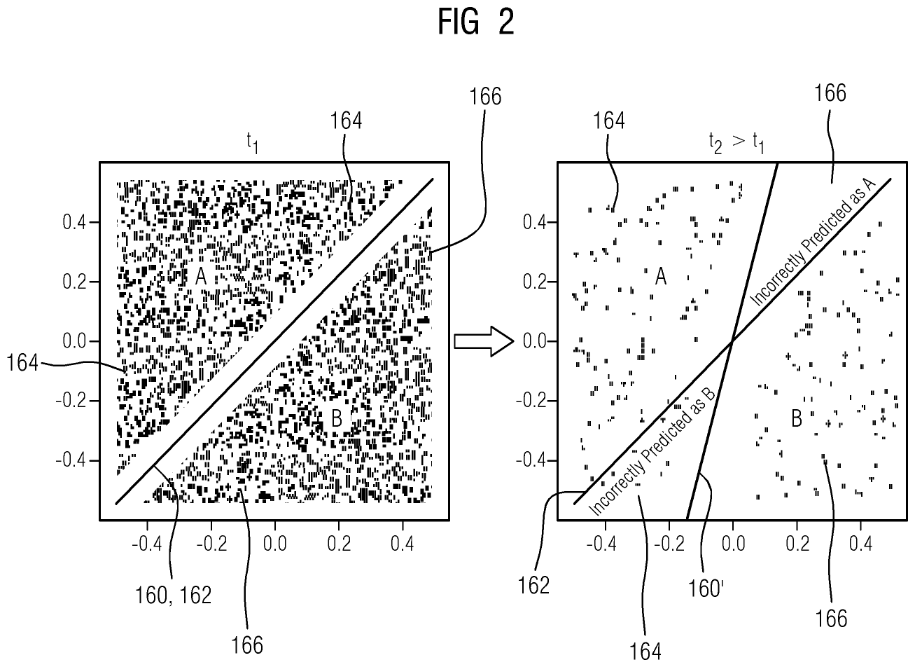

By way of example, the input data messages 140 comprise a variable, wherein for a given period of time the values of this variable oscillate around a given mean value. For some reason, at a later time, the values of this variable oscillate around a different mean value so that a distribution drift has occurred. The distribution may, in many examples, involve a decrease of the determined accuracy value of the trained function. By way of example, a distribution drift of a variable may occur due to wear, ageing or other sorts of deterioration, e.g., for devices which are subject to mechanical or stress. The concept of a distribution drift leading to a decreased accuracy of the trained function is explained in more details below in the context of FIG. 2.

In some examples, the suggested methods may hence detect an accuracy decrease of a trained function due to a distribution drift of incoming data messages 140.

It should also be appreciated, that in some examples, the application software component 106 and/or the processor 102 may further be configured to manipulate the respective distance by one of scaling, bootstrapping, norming or any combination thereof.

Bootstrapping is any test or metric that uses random sampling with replacement, e.g., mimicking the sampling process, and falls under the broader class of resampling methods. Bootstrapping assigns measures of accuracy, such as bias, variance, confidence intervals, prediction error, etc., to sample estimates. This technique allows estimation of the sampling distribution of almost any statistic using random sampling methods. Further, bootstrapping estimates the properties of an estimator, such as its variance, by measuring those properties when sampling from an approximating distribution. One standard choice for an approximating distribution is the empirical distribution function of the observed data. In the case where a set of observations can be assumed to be from an independent and identically distributed population, this can be implemented by constructing a number of resamples with replacement, of the observed data set, and of equal size to the observed data set.

The norming of the determined distances may be done, e.g., using the triangle inequality stating that for any triangle, the sum of the lengths of any two sides must be greater than or equal to the length of the remaining side.

Herein, the manipulation the respective distance ensures the comparability among different value ranges and length-ratios between variables and the reference data set.

It should also be appreciated, that in some examples, the regression model is a trained regression model and the application software component 106 and/or the processor 102 may further be configured to provide a regression training data set comprising raw data and drifted raw data, to determine a respective distance vector x and a respective accuracy value y using the regression training data set; and to train the regression model x→y to obtain the trained regression model using the regression training data set.

In some examples, the raw data may comprise data with respect to one or more variables which may be observed if the device 142 or a production plant comprising the device 142 has been commissioned and been started to operate. Hence, wear, ageing or other sorts of deterioration may not yet be expected for the device 142 or the production plant. The drifted raw data may then comprise data with respect to the one or more variables which may be observed the device 142 or the production plan comprising the device 142 has been operated for the certain period of time and wear, ageing or other sorts of deterioration observable. For example, the raw data may comprise temperature data of a bearing with a comparably low operation temperature, whereas the drifted raw data may comprise temperature data bearing with a comparably high operation temperature which is due to increased wear and friction.

Using the regression training data set, a distance vector x and a respective accuracy value y may be determined and the regression model x→y may be trained to obtain the trained regression model. Further details are explained below in the context of a more refined embodiment.

In further examples, the application software component 106 and/or the processor 102 may further be configured—if the determined accuracy value is equal to or greater than the accuracy threshold—to embed the trained function 120 in a software application for analyzing, monitoring, operating and/or controlling the at least one device 142, and to deploy the software application on the at least one device 142 or an IT system connected to the at least one device 142 such that the software application may be used for analyzing, monitoring, operating and/or controlling the at least one device 142.

The software application may, e.g., be a condition monitoring application to analyze and/or money for the status of the respective device 142 or of a production step carried out by the respective device 142. In some examples, the software application may be an operating application or a control application to operate or control the respective device 142 or the production step carried out by the respective device 142. The trained function 120 may be embedded in such the software application, e.g., to derive status information of the respective device 142 or the respective production step order to derive operating or control information for the respective device of the respective production step. The software application may then be deployed on the respective device 142 or the IT system. The software application may then be provided with the input data messages 140 which may be processed using the trained function 120 to determine the output data 152.

In some examples, a software application may be understood as deployed if the activities which are required to make this software application available for use on the respective device 142 or the IT system, e.g., by a user using the software application on the respective device 142 or the IT system. The deployment process of the software application may comprise several interrelated activities with possible transitions between them. These activities may occur at the producer side (e.g., by the developer of the software application) or at the consumer side (e.g., by the user of the software application) or both. In some examples, the app deployment process may comprise at least the installation and the activation of software application, and optionally also the release of the software application. The release activity may follow from the completed development process and is sometimes classified as part of the development process rather than deployment process. It may comprise operations required to prepare a system (here: e.g., the processing system 100 or computation unit 124) for assembly and transfer to the computer system(s) (here: e.g., the respective device 142 or the IT system) on which it will be run in production. Therefore, it may sometimes involve determining the resources required for the system to operate with tolerable performance and planning and/or documenting subsequent activities of the deployment process. For simple systems, the installation of the software application may involve establishing some form of command, shortcut, script or service for executing the software (manually or automatically) of the software application. For complex systems, it may involve configuration of the system—possibly by asking the end user questions about its intended use, or directly asking them how they would like it to be configured—and/or making all the required subsystems ready to use. Activation may be the activity of starting up the executable component of software application for the first time (which is not to be confused with the common use of the term activation concerning a software license, which is a function of Digital Rights Management systems.)

It should further be appreciated that in some examples, the application software component 106 and/or the processor 102 may further be configured—if the determined accuracy value is smaller than the accuracy threshold or a higher, first accuracy threshold—to amend the trained function 120 such that a determined amended accuracy value of the amended trained function 120 for the respective distance using the regression model 130 is greater than the accuracy threshold, to replace the trained function 120 with the amended trained function 120 in the software application to obtain an amended software application, and to deploy the amended software application on the at least one device 142 or the IT system.

If the determined accuracy value is smaller than the (first) accuracy threshold, the trained function 120 may be amended, e.g., by introducing an offset or factor with respect to the variable, so that the accuracy value using the amended trained function is greater than the accuracy threshold. For determining the accuracy value of the amended trained function, the same procedure may apply as for the trained function 120, i.e., determining a respective distance of the respective variable of the respective input data message 140 to the reference data set and then determining the amended accuracy value of the amended trained function using the respective distance and the regression model 130. By way of example, the amended trained function may be found by varying the parameters of the trained function 120 and calculating the corresponding amended accuracy value. If the amended accuracy value for a given set of varied parameters is greater than the accuracy threshold, varied parameters may be used in the amended trained function which complies with the accuracy threshold.

In some examples, amending the trained function 120 may already be triggered at the slightly higher, first accuracy threshold corresponding to a higher trustworthiness. Hence, the trained function 120 may still result in acceptable quality for analyzing, monitoring, operating and/or controlling the respective device 142, although having a better, trained function 120 may be desirable. In such a case, amending the trained function 120 may already be triggered to obtain an improved, amended trained function leading to a higher amended accuracy value. Such an approach may allow for always having a trained function with a high trustworthiness, comprising scenarios with a data distribution drift, e.g., related to wear, ageing or other sorts of deterioration. By way of example, the accuracy threshold may be 95% and the first accuracy threshold may be 98%. Using the slightly higher, first accuracy threshold may take into account a certain latency between and decreasing accuracy value for the trained function 120 and determining an amended trained function with a higher accuracy value and hence higher trustworthiness. Such a scenario may correspond to an online retraining or permanent retraining of the trained function 120.

In the software application, the trained function 120 may then be replaced with the amended trained function which may then be deployed at the respective device 142 or the IT system.

In further examples, the application software component 106 and/or the processor 102 may further be configured to use a plurality of received input data messages 140 as a training data set, wherein the plurality of received input data messages 140 are characterized by a distribution drift involving a decrease of the accuracy value of the trained function 120, and to train the trained function 120 with the training data set to obtain the amended trained function.

Input data messages 140 which underwent a distribution drift with respect to the previously received input data messages 140 and/or with respect to the reference data set may, e.g., be used to retrain the trained function 120 to obtain the amended trained function. In some examples, this retraining is done if the determined accuracy value is smaller than the accuracy threshold, in some examples, the determined accuracy value is smaller than the first accuracy threshold.

By way of example, if the determined accuracy value is smaller than the accuracy threshold or the first accuracy threshold, a process of collecting input data messages 140, optionally of data cleansing, then of retraining the trained function 120, of embedding the retrained function in the software application to obtain the amended software application, and of eventually deploying the software application with the embedded retrained function on the respective device 140 for the IT system may be started.

In further examples, the application software component 106 and/or the processor 102 may further be configured—if the amendment of the trained function 120 takes more time than a duration threshold—to replace the deployed software application with a backup software application, and to analyze, monitor, operate and/or control the at least one device 142 using the backup software application.

In some examples, suitably amending the trained function 120 may take longer time than a duration threshold. This may, e.g., occur in the previously mentioned online retraining scenarios if there is a lack of suitable training data or if there are limited computation capacities. In such cases, a backup software application may be used to analyze, monitored, operated and/or control the respective device 142. The backup software application may, e.g., put the respective device 142 in a safety mode, e.g., to avoid damages or harm to persons or to a related production process. In some examples, the backup software application may shut down the respective device 142 or the related production process. In further examples, e.g., involving a collaborated robot or other devices 142 which are intended for direct human robot/device interaction within a shared space, or where humans and robots/devices are in close proximity, the application may switch the corresponding device 142 to a slow mode thereby also avoiding harm to persons. Such scenarios may, e.g., comprise car manufacturing plants or other manufacturing facilities with production or assembly lines in which machines and humans work in a shared space and in which the backup software application may switch the production or assembly line to such a slow mode.

It should further be appreciated that in some examples, for a plurality of interconnected devices 142, the application software component 106 and/or the processor 102 may further be configured to embed a respective trained function 120 in a respective software application for analyzing, monitoring, operating and/or controlling the respective interconnected device(s) 142, to deploy the respective software application on the respective interconnected device(s) 142 or an IT system connected to the plurality of interconnected devices 142 such that the respective software application may be used for analyzing, monitoring, operating and/or controlling the respective interconnected device(s) 142, to determining a respective accuracy value of the respective trained function 120, and to provide an alarm 150 relating to the respective, determined accuracy value and the respective interconnected device(s) 142 for which the corresponding respective software application is used for analyzing, monitoring, operating and/or controlling the respective interconnected device(s) 142 to a user, to the respective device(s) 142 and/or an IT system connected to the respective device(s) 142, if the respective, determined accuracy value is smaller than a respective accuracy threshold.

The interconnected devices 142 may, by way of example, be part of a more complex production or assembly machine or even constitute a complete production or assembly plant. In some examples, a plurality of trained functions 120 is embedded in a respective software application to analyze, monitor for, operate and/or control one or more of the interconnected device(s) 142, wherein the trained functions 120 and the corresponding devices 142 may interact and cooperate. In such scenarios it may be challenging to identify the origin of problems that may occur during the operation of the interconnected devices 122. In order to overcome such difficulties, the respective accuracy value of the respective trained function 120 is determined and, if the respective, determined accuracy value is smaller than a respective accuracy threshold, an alarm 152 may be provided which relates to the respective, determined accuracy value and the respective interconnected device(s) 142. This approach allows for a root cause analysis in a complex production environment involving a plurality of trained functions 120 which are embedded in corresponding software applications deployed on a plurality of interconnected devices 142. Hence, a particularly high degree of transparency is achieved allowing for fast and efficient identification and correction of errors. By way of example, in such a complex production environment, a problematic device 142 among the plurality of interconnected devices 142 can easily be identified and by amending the respective trained function 120 of this problematic device 142 the problem can be solved.

In the context of these examples, there may be scenarios with one respective trained function 120 for each device 142, with a plurality of trained functions 120 for each device 142, or with a plurality of trained functions 120 for a plurality of devices 142. Hence, there may be a one-to-one correspondence, a one-to-many correspondence, a many-to-one correspondence, or a many-to-many correspondence between trained functions 120 and devices 142.

It should also be appreciated that in further examples, the respective device 142 is any one of a production machine, an automation device, a sensor, a production monitoring device, a vehicle or any combination thereof.

As already mentioned above, the respective device 142 may, in some examples, may be or comprise a sensor, an actuator, such as an electric motor, a valve or a robot, and inverter supplying an electric motor, a gear box, a programmable logic controller (PLC), a communication gateway, and/or other parts component relating to industrial automation products and industrial automation in general. The respective device 142 may be (part of) a complex production line or production plant, e.g., a bottle filing machine, conveyor, welding machine, welding robot, etc. Further, by way of example, the respective device may be or comprise a manufacturing operation management (MOM) system, a manufacturing execution system (MES), and enterprise resource planning (ERP) system, a supervisory control and data acquisition (SCADA) system, or any combination thereof.

In an industrial embodiment, the suggested method and system may be realized in the context of an industrial production facility, e.g., for producing parts of product devices (e.g., printed circuit boards, semiconductors, electronic components, mechanical components, machines, devices, vehicles or parts of the vehicle's, such as cars, cycles, airplanes, ships, or the like) or an energy generation or distribution facility (power plant in general, transformers, switch gears, the like). By way of example, the suggested method and system may be applied to certain manufacturing steps during the production of the product device, such as milling, grinding, welding, forming, painting, cutting, etc., e.g., monitoring or even controlling the welding process, e.g., during the production of cars. In particular, the suggested method and system may be applied to one or several plants performing the same task at different locations, whereby the input data may originate from one or several of these plants which may allow for a particularly good database for further improving the trained function 120 and/or the quality of the analysis, the monitoring, the operation and/or the control of the device 142 or plant(s).

Here, the input data 140 may originate from devices 142 of such facilities, e.g., sensors, controllers, or the like, and the suggested method and system may be applied to improve analyzing, monitoring, operating and/or controlling the device 142 or the related production or operation step. To this end the trained function 120 may be embedded in a suitable software application which may then be deployed on the device 142 or a system, e.g., an IT system, such that the software application may be used for the mentioned purposes.

It should also be appreciated that in some examples, convergence of the mentioned training is not an issue so that no stop criteria may be needed. This may be due to the trained function 120 being rather an analytical function is only a finite number of iteration steps may be required. Also, the convergence in the regression model may in most cases be given. Concerning the artificial neural network, the minimum number of nodes generally may depend on specifics of the algorithm, whereby in some examples, for the present invention, a one-class support vector machine (SVM) may be used. Further, the minimum number of nodes of the used artificial neural network may depend on the number of dimensions of the input data messages, e.g., two dimensions (e.g., for two separate forces) or 20 dimensions (e.g., for 20 corresponding physical observable tabular data or timeseries data).

FIG. 2 illustrates a degradation of a trained model in time due to a data distribution shift. Herein, the model may correspond to the trained function 120.

In ideal situation, a model trained on acquired data has to perform excellent on an incoming stream of data. However, an analytical model degrades with a time and a model trained at time t₁ might perform worse at time t₂.

For purposes of illustration, a binary classification between classes A and B for two-dimensional datasets are considered. At time t₁ a data analyst trains a model which is able to build a decision boundary 162 between data belonging to either class A (cf. data point 164) or class B (cf. data points 166). In this case, a build decision boundary 162 corresponds to a real boundary 160 which separates these two classes. At the time being deployed, a model generally performs excellent. However, at later time t₂>t₁, an incoming data stream or input data messages 140 might experience a drift in a data distribution and by this, might have an effect on performance of the model. One can see this phenomenon on the right-hand side of FIG. 2: data points 166 belonging to class B drift towards the right lower corner and data points 164 belonging to class A in an opposite direction. Therefore, a previously build decision boundary 162 does not correspond to new data distributions of classes A and B since the new, real boundary 160′ separating two classes has moved. Hence, the analytical model must be retrained as soon as possible.

Among others, one goal of the suggested approach may comprise to develop a method for detecting a performance drop or decrease of a trained model (e.g., the trained function 120) under data distribution shift in data streams, such as sensor data streams or input data messages 140. Note that in some examples, high data drift alone does not mean bad prediction accuracy of a trained model (e.g., the trained function 120). It may finally be necessary to correlate this drift with the ability of the old model to handle the data drift, i.e., measure the current accuracy. In some examples, once a performance drop or accuracy decrease is detected, the data analyst may retrain the model based on new character of incoming data.

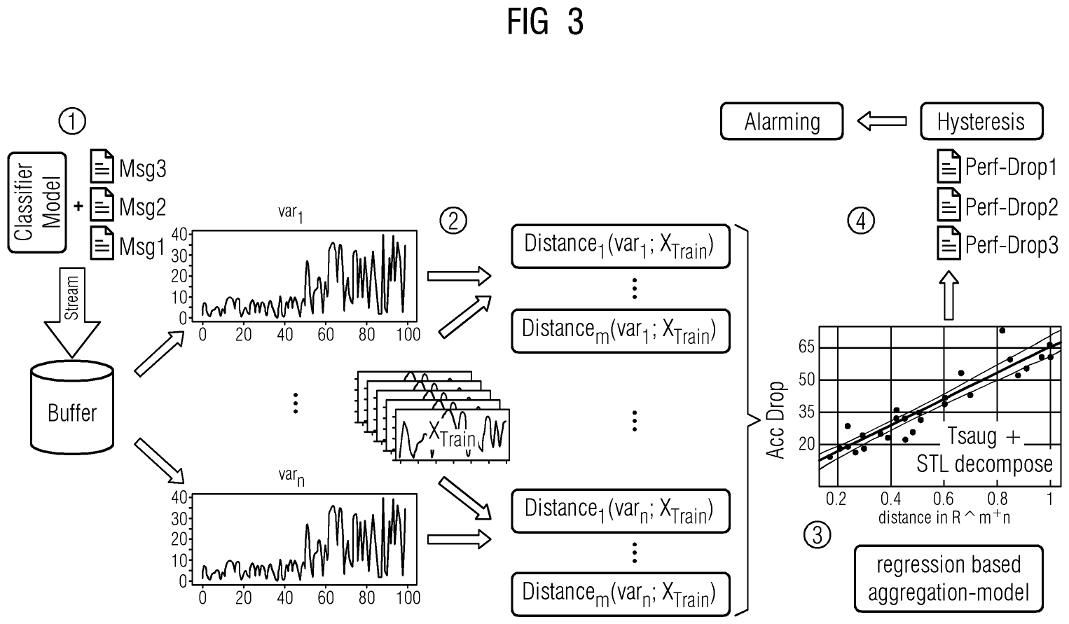

FIG. 3 illustrates a flow diagram of an example methodology that facilitates providing an alarm in a product system. In an example embodiment of the invention, one or more of the following steps may be used:
1) Receive input data comprising an incoming stream of input data messages 140 and optionally put messages in some storage, e.g., buffer or low access-time storage allowing for a desired sampling frequency; optionally, the machine learning model (e.g., the trained function 120, the regression model 130) and/or the training/reference data set may be received as an input; the messages may comprise information on one or several variables, such as sensor data with respect to electric current, electric voltage, temperature, noise, vibration, optical signals, or the like;
2) Measure difference of a new message compared to the known training set, e.g., by determining distances between the new message and the known training set, such as an energy distance
3) For every incoming message: compute distances for each variable;
   Example distances comprise (in the time-domain:) energy distance or alternatives Wasserstein distance, ks distance, Jensen-Shannon distance, distance over cumsum, DTW distance and (in the frequency domain:) in different norms in Fourier, wavelet and tsfresh space;
   Bring all calculated distances to same space to allow for comparability: scaling, bootstrapping, and norming, e.g., using the triangle inequality, of these distances: ensuring comparability among different value ranges and length-ratios between variables and training set.
   These sub-steps provide a distance vector (for each variable of each message).
4) The obtained distance vector is mapped to an accuracy drop (=decrease of accuracy) of the use case machine learning model (e.g., the trained function 120) via the regression model (“aggregation logic”) so that an accuracy value may be obtained. The regression model may be trained beforehand since the calculation of the accuracy may not be possible in real-time. The training of the regression model may be based on the training data set and the trained ML model (e.g., trained function).

5) If the accuracy falls below a threshold (e.g., 98% for N sequentially incoming messages, whereby some outliers may be allowed), a report, warning or alert 150 may be sent that the current model might be not reliable anymore (e.g., the output data being the report relating to the determined accuracy value).
6) Optionally,
   the report or alert 150 may comprise the indication “warning”, if the determined accuracy value falls below a first threshold (e.g., 99%), then collecting data may be started, the collected data may be data labelled (in a supervised case), and the use case machine learning model (e.g., the trained function) may be adopted;
   if the determined accuracy value falls below a second threshold (e.g., 95%), the report may comprise the indication “error”, and the use case machine learning model (e.g., the trained function) may be replaced with the amended use case machine learning model (e.g., the amended trained function)

The embodiment along with the present invention has several advantages comprising:
Fully automatic procedure, no labels (for incoming messages) required,
Robust method thanks to different distance calculations, allows to indicate the most important contributors, e.g., for observed behavior,
Linking this drift measurements to the model performance,
No hand-crafted thresholds necessary which are use case- and data-specific,
Automatic deployment is possible and enabled, there is no manual input required.
It is a computationally efficient method allowing for being run on edge device, e.g., with comparably small computation or storage resources; in some cases, a previous emulation on the cloud may be required and perhaps adaptation of the algorithm to the resources of edge device may be advisable or required.

In a more refined embodiment, one or more of the following steps may be used:
1) We expect the use case machine learning (ML) model (e.g., the trained function 120), the training/reference data set X_{Train} and an incoming stream of input data messages 140 as input. Each message is identified by a timestamp or a unique id and contains one numerical value (type A) or an array of values (type B) for each variable.
   Incoming messages are collected inside a buffer, for providing a minimum sample size in the next processing step.
2) Next step is to measure the “novelty” or difference of the new message in respect to our already known training set. We are applying different distances here, one of them being the energy distance (cf., e.g., https://en.wikipedia.org/wiki/Energy distance): The energy distance between two distributions u and v, whose respective CDFs are U and V, equals to

D(u,v)=(2 [symbol] X−Y|− [symbol] X−X′|− [symbol] Y−Y′|)^{1/2}
where X and X′ (resp. Y and Y′) are independent random variables whose probability distribution is u (resp. v). Next steps are applied for every incoming message: For each variable vari=1 m inside our data block we compute Distanceⱼ(varᵢ, X_{Train}), j=1 . . . m by choosing a subset (which depends on type of incoming messages) of distances from a global set {wasserstein dist, energy dist, ks dist, Jensen-Shannon dist, dist over cumsum, DTW dist} as well as distances in different norms in Fourier, wavelet and tsfresh space. These distances are scaled, bootstrapped and normed by triangle inequality for ensuring comparability among different value ranges and length-ratios between varᵢ, X_{Train}.
3) After computing all distances (and averaging over the bootstrap sets) we end up with a distance vector of length x m which is mapped to an accuracy drop (accuracy value) of our use case ML (“machine learning”) model via a regression model (“aggregation logic”). This regression model needs to be trained before deployment of use case model, as the calculation of accuracy may not be possible in real-time, due to delayed label arriving.
   Whereas distances might be computed right away and used for accuracy drop forecast.
   Few more details on our regression model:
   i. First, we need to extract subsamples s_{raw}ϵX_{Train} and zip them with s_{mod}, where s_{mod} is being generated out of s_{raw} by different artificial drifts. Each drift is specified by a linear combination of drift types coming from python library tsaug.
   ii. For each of such tuples (s_{raw}, s_{mod})ᵢ we compute the n×m dimensional distance vector xᵢ and the accuracy drop yᵢ=|acc(model.predict(s_{raw}))−acc(model.predict(s_{mod}))|
   iii. Finally, we build X=[x₁, . . . , xᵣ] and Y=[y₁, . . . , yᵣ] and train our regression model: X→y

The described method 1) to 3) of the refined embodiment is suitable for any given supervised (i) and unsupervised (ii) use case model. One needs only to adjust the calculation of the accuracy, which differs for (i) from (ii).

This procedure is applied for every incoming message and forecasted accuracy drop stored in a second buffer. Alarming for bad reliability is triggered threshold based. The threshold is chosen in order to pick the accuracy drop within certain percentage. For example, the model developed for ML task performs with accuracy 100% on testing dataset before deployment, and requirements of ML task is having accuracy not less than 98%. After deployment utilizing our approach one can detect an accuracy drop with respect to a mentioned above aggregation logic. If our forecasted accuracy drop exceeds 2% our method sends a warning that the current model might be not reliable anymore.

In order to avoid (unnecessary) false positives, we suggest the following workflow:
Having trained ML model deploy the model,
Start data stream,
For every incoming message utilize a method described above if the accuracy drop exceeds certain percentage (in our example 2%) sequentially for N incoming messages warn the user that data distribution drift occurs.
If accuracy drop occurs not in sequential order—ignore it.

In comparison with other approaches, the suggested method offers these advantages:
1) For detection of a data distribution drift after artificial intelligence (AI) model is deployed our solution does not need any labels and performs the detection in fully automated way.
2) The solution employs different distance calculations in order to directly detect data distribution drift without performing intermediate computations indicating the most important contributors to the drift and therefore more robust to multidimensional datasets.
3) The solution is focusing not only on data drift detection, but moreover quantifies data drift in a multidimensional distance space and links this drift measurements to the model performance. This link is necessary, because a strong evidence for data distribution drift alone, does not necessarily mean a drop in the accuracy of AI model. Data drift alone has no direct correlation on the trustworthiness of the model.
4) The methods used in other approaches are either using one-dimensional distances and foremost they are focusing on a data distribution drift detection itself and not on measuring performance drop—provided some data drift.
5) Most of the other approaches are operating in e-commerce area or/and computer vision area and therefore are providing solutions mostly based on certain use cases Our method is applicable to the working to a huge extend in an automized way, for tabular and time series data and for supervised and unsupervised models.
6) The other approaches are often relying on hand-crafted thresholds, which are use case- and data-specific.
7) Using an ML model itself for monitoring the initial use case model and is doing it in a multivariate way. This approach replaces manual threshold monitoring and provides hope and space for scaling and generalizability.

In general, the suggested method provides:
Better performance and efficiency,
More robust to usage in multidimensional dataset,
Being deployed is fully automated,
Computationally efficient ang can be ran at any suitable edge device,
Fits to a wide range of industrial products and solutions.

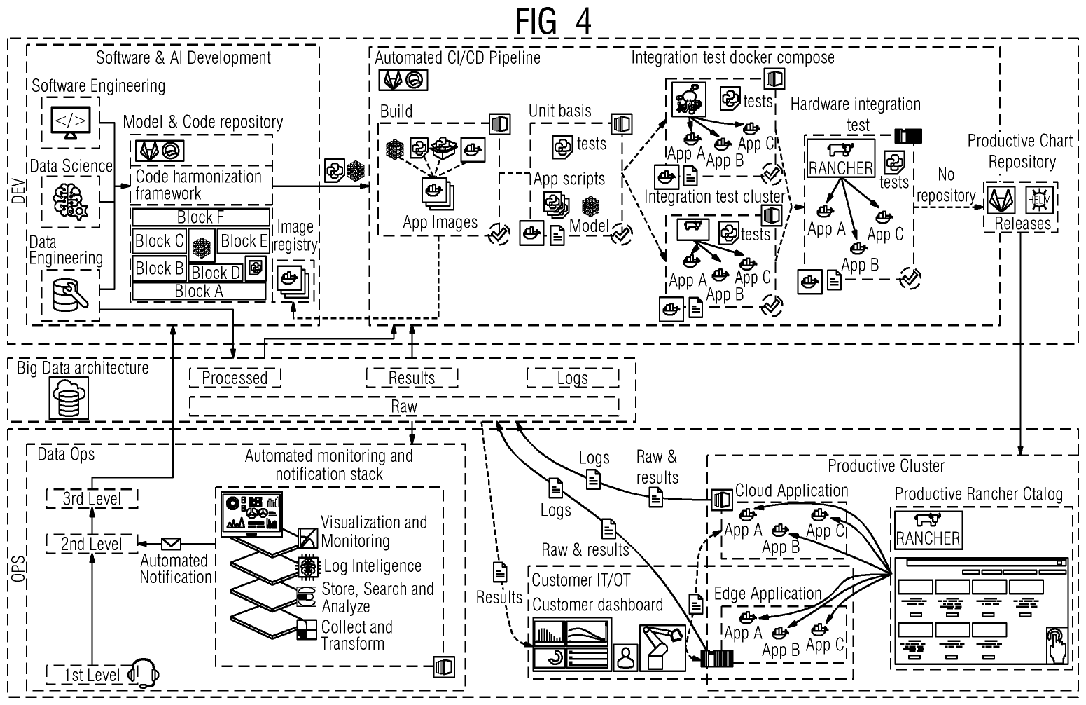

FIG. 4 illustrates a functional block diagram of an example system that facilitates providing an alarm and managing computer software products in a product system.

The overall architecture of the illustrated example system may be divided in development (“dev”), operations (“ops”), and a big data architecture arranged in between development and operations. Herein, dev and ops may be understood as in DevOps, a set of practices that combine software development (Dev) and IT operations (Ops). DevOps aims to shorten the systems development life cycle and provide continuous delivery with high software quality. By way of example, the trained function explained above may be developed or refined and then be embedded in a software application in the “dev” area of the illustrated system, whereby the trained function of the software application is then operated in the “ops” area of the illustrated system. The overall idea is to enable adjusting or refining the trained model or the corresponding software solution based on operational data from the “ops” are which may be handled or processed by the “big data architecture”, whereby the adjustment or refinement is done in the “dev” area.

On the bottom right, i.e., in the “ops” area, a deployment tool for apps (such as software applications) with various micro services called “Productive Rancher Catalogue” is shown. It allows for data import, data export, a MQTT broker and a data monitor. The Productive Rancher Catalogue is part of a “Productive Cluster” which may belong to the operations side of the overall “Digital Service Architecture”. The Productive Rancher Catalogue may provide software applications (“Apps”) which may be deployed as cloud applications in the cloud or as edge applications on edge devices, such as devices and machines used in an industrial production facility or an energy generation or distribution facility (as explained in some detail above). The micro services may, e.g., represent or be comprised in such applications. The devices on which the corresponding application is running (or the application running on the respective device) may deliver data (such as sensor data, control data, etc.), e.g., as logs or raw data (or, e.g., input data), to a cloud storage named “Big data architecture” in FIG. 4.

This input data may be used on the development side (“dev”) of the overall Digital Service Architecture to check whether the trained model (e.g., the trained function) (cf. “Your model” in the block “Code harmonization framework” in the block “Software & AI Development”) is still accurate or needs to be amended (cf. determining of accuracy value and amending the trained model, if the determined accuracy value is below a certain threshold). In the “Software & AI Development” area, there may be templates and AI models, and optionally the training of a new model may be performed. If an amendment is required, the trained model is amended accordingly and during an “Automated Cl/CD Pipeline” (Cl/CD=continuous integration/continuous delivery or continuous deployment) embedded in an application which may deployed as cloud application in the cloud or as edge application on edge devices when transferred to the Protective Cluster (mentioned above) of the operations side of the overall Digital Service Architecture.

The Automated Cl/CD Pipeline may comprise:
Build “Base Image” & “Base Apps”->build App Image and App
Unit tests: software tests, machine learning model testing
Integration test (docker on a machine, or cluster, e.g., Kubernetes cluster)
HW (=hardware) integration test (deployment on real edge device/edge box)
A new Image may be obtained suitable for release/deployment in the Productive Cluster

The described update or amendment of the trained model (e.g., the trained function) may be necessary, e.g., if a sensor or device is broken, has a malfunction on generally needs to be replaced. Also, sensors and devices are ageing so that a new calibration may be required from time to time. Such events may result in a trained model which is no more trustworthy, but rather needs to be updated.

The advantage of the suggested method and system embedded in such a Digital Service Architecture is that an update of a trained model (e.g., the trained function) may be performed as quick as the replacement of the sensor or a device, e.g., only 15 minutes of recovery time are also needed for programming and deployment of a new trained model and an according application which comprises the new trained model. Another advantage is that the update of a deployed trained model and the corresponding application may be performed fully automatically.

The described examples may provide an efficient way to provide alarm relating to an accuracy of a trained function, such as detecting an accuracy decrease of a trained function under a distribution drift of incoming data, thereby enabling driving the digital transformation and empowering machine learning applications to influence and even maybe shape processes. One important aspect contribution of the present invention is that it helps assuring the trustworthiness of such applications in a highly volatile environment on the shop floor. The present invention may support handling this challenge by providing a monitoring and alarming system, which helps to react properly, once the machine learning application is not behaving in the way it was trained to do. Thus, the described examples may reduce the total cost of ownership of the computer software products in general, by improving their trustworthiness and supporting to keep them up to date. Such efficient provision of output data and management of computer software products may be leveraged in any industry (e.g., Aerospace & Defense, Automotive & Transportation, Consumer Products & Retail, Electronics & Semiconductor, Energy & Utilities, Industrial Machinery & Heavy Equipment, Marine, or Medical Devices & Pharmaceuticals). Such efficient provision of output data and management of computer software products may also be applicable to a consumer facing the need of trustworthy and up to date computer software products.

In particular, the above examples are equally applicable to the computer system 100 arranged and configured to execute the steps of the computer-implemented method of providing output data, to the corresponding computer program product and to the corresponding computer-readable medium explained in the present patent document, respectively.

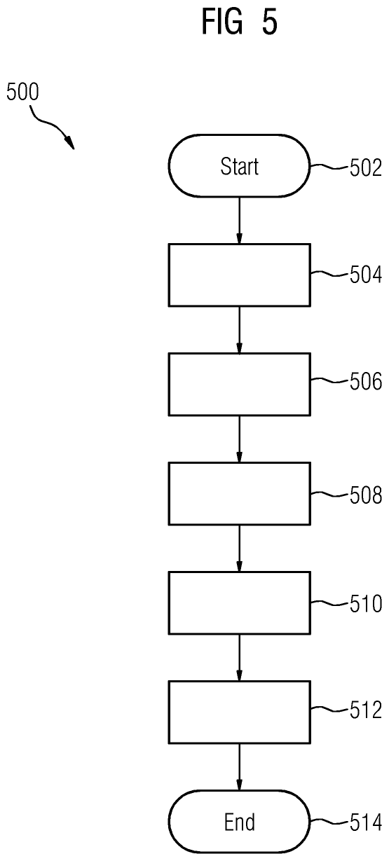

Referring now to FIG. 5, a methodology 500 that facilitates providing an alarm relating to an accuracy of a trained function, in particular for detecting an accuracy decrease of a trained function under a distribution drift of incoming data is illustrated. The method may start at 502 and the methodology may comprise several acts carried out through operation of at least one processor.

These acts may comprise an act 504 of receiving input data messages relating to at least one variable of at least one device; an act 506 of applying a trained function to the input data messages to generate output data, the output data being suitable for analyzing, monitoring, operating and/or controlling the respective device; an act 508 of determining at least one respective distance of the respective variable of a respective received input data message to a reference data set, an act 510 of determining an accuracy value of the trained function using the respective distance and a regression model; and—if the determined accuracy value is smaller than an accuracy threshold—an act 512 of providing an alarm relating to the determined accuracy value to a user, to the respective device and/or an IT system connected to the respective device. At 514 the methodology may end.

It should be appreciated that the methodology 500 may comprise other acts and features discussed previously with respect to the computer-implemented method of providing an alarm relating to an accuracy of a trained function, such as detecting an accuracy decrease of a trained function under a distribution drift of incoming data.

For example, the methodology may further comprise the act of manipulating the respective distance by one of scaling, bootstrapping, norming or any combination thereof.

It should also be appreciated that in some examples, the regression model is a trained regression model, and the methodology may further comprise the act of providing a regression training data set comprising raw data and drifted raw data; the act of determining a respective distance vector x and a respective accuracy value y using the regression training data set; and the act of training the regression model x→y to obtain the trained regression model using the regression training data set.

In some examples, if the determined accuracy value is equal to or greater than the accuracy threshold, the methodology may further comprise the act of embedding the trained function in a software application for analyzing, monitoring, operating and/or controlling the at least one device; and the act of deploying the software application on the at least one device or an IT system connected to the at least one device such that the software application may be used for analyzing, monitoring, operating and/or controlling the at least one device.

In further examples, if the determined accuracy value is smaller than the accuracy threshold or a higher, first accuracy threshold, the methodology may further comprise the act of amending the trained function such that a determined amended accuracy value of the amended trained function for the respective distance using the regression model is greater than the accuracy threshold; the act of replacing the trained function with the amended trained function in the software application to obtain an amended software application; and the act of deploying the amended software application on the at least one device or the IT system.

It should also be appreciated that in some examples, the methodology may further comprise the act of using a plurality of received input data messages as a training data set, wherein the plurality of received input data messages are characterized by a distribution drift involving a decrease of the accuracy value of the trained function; and the act of training the trained function with the training data set to obtain the amended trained function.

In some examples, if the amendment of the trained function takes more time than a duration threshold, the methodology may further comprise the act of replacing the deployed software application with a backup software application; and the act of analyzing, monitoring, operating and/or controlling the at least one device using the backup software application.

As discussed previously, acts associated with these methodologies (other than any described manual acts such as an act of manually making a selection through the input device) may be carried out by one or more processors. Such processor(s) may be comprised in one or more data processing systems, for example, that execute software components operative to cause these acts to be carried out by the one or more processors. In an example embodiment, such software components may comprise computer-executable instructions corresponding to a routine, a sub-routine, programs, applications, modules, libraries, a thread of execution, and/or the like. Further, it should be appreciated that software components may be written in and/or produced by software environments/languages/frameworks such as Java, JavaScript, Python, C, C#, C++ or any other software tool capable of producing components and graphical user interfaces configured to carry out the acts and features described herein.

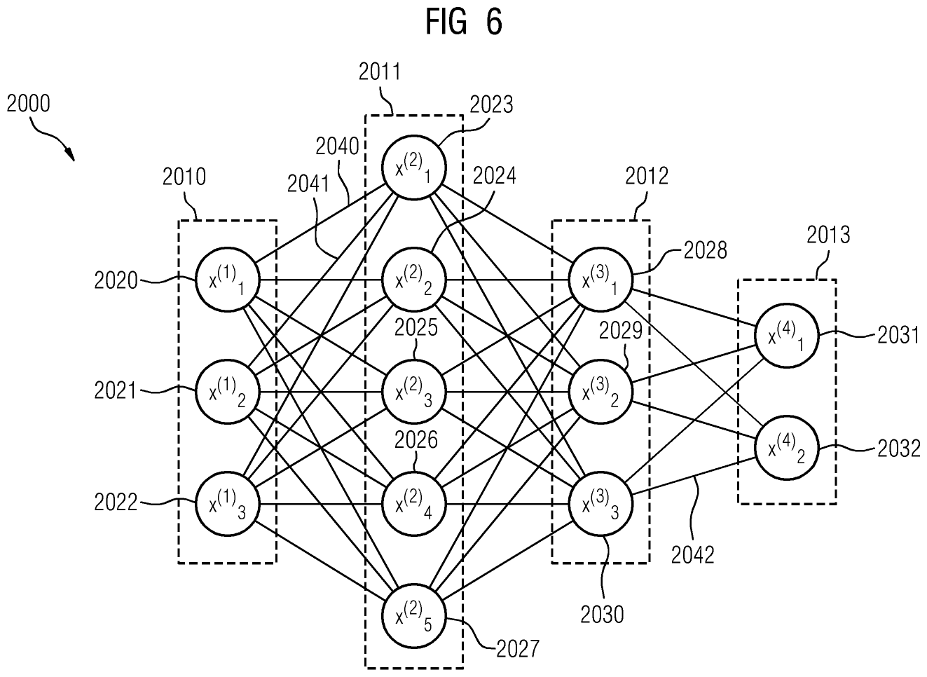

FIG. 6 displays an embodiment of an artificial neural network 2000 which may be used in the context of providing an alarm relating to an accuracy of a trained function, in particular for detecting an accuracy decrease of a trained function under a distribution drift of incoming data. Alternative terms for “artificial neural network” are “neural network”, “artificial neural net” or “neural net”.

The artificial neural network 2000 comprises nodes 2020, . . . , 2032 and edges 2040, . . . , 2042, wherein each edge 2040, . . . , 2042 is a directed connection from a first node 2020, . . . , 2032 to a second node 2020, . . . , 2032. In general, the first node 2020, . . . , 2032 and the second node 2020, . . . , 2032 are different nodes 2020, . . . , 2032, it is also possible that the first node 2020, . . . , 2032 and the second node 2020, . . . , 2032 are identical. For example, in FIG. 6 the edge 2040 is a directed connection from the node 2020 to the node 2023, and the edge 2042 is a directed connection from the node 2030 to the node 2032. An edge 2040, . . . , 2042 from a first node 2020, . . . , 2032 to a second node 2020, . . . , 2032 is also denoted as “ingoing edge” for the second node 2020, . . . , 2032 and as “outgoing edge” for the first node 2020, . . . , 2032.

In this embodiment, the nodes 2020, . . . , 2032 of the artificial neural network 2000 can be arranged in layers 2010, . . . , 2013, wherein the layers can comprise an intrinsic order introduced by the edges 2040, . . . , 2042 between the nodes 2020, . . . , 2032. In particular, edges 2040, . . . , 2042 can exist only between neighboring layers of nodes. In the displayed embodiment, there is an input layer 2010 comprising only nodes 2020, . . . , 2022 without an incoming edge, an output layer 2013 comprising only nodes 2031, 2032 without outgoing edges, and hidden layers 2011, 2012 in-between the input layer 2010 and the output layer 2013. In general, the number of hidden layers 2011, 2012 can be chosen arbitrarily. The number of nodes 2020, . . . , 2022 within the input layer 2010 usually relates to the number of input values of the neural network, and the number of nodes 2031, 2032 within the output layer 2013 usually relates to the number of output values of the neural network.

In particular, a (real) number can be assigned as a value to every node 2020, . . . , 2032 of the neural network 2000. Here, x(n)i denotes the value of the i-th node 2020, . . . , 2032 of the n-th layer 2010, . . . , 2013. The values of the nodes 2020, . . . , 2022 of the input layer 2010 are equivalent to the input values of the neural network 2000, the values of the nodes 2031, 2032 of the output layer 2013 are equivalent to the output value of the neural network 2000. Furthermore, each edge 2040, . . . , 2042 can comprise a weight being a real number, in particular, the weight is a real number within the interval [−1, 20] or within the interval [0, 20]. Here, w^{(m,n)}_{i,j} denotes the weight of the edge between the i-th node 2020, . . . , 2032 of the m-th layer 2010, . . . , 2013 and the j-th node 2020, . . . , 2032 of the n-th layer 2010, . . . , 2013. Furthermore, the abbreviation w⁽ⁿ⁾_{i,j} is defined for the weight w^{(n,n+1)}_{i,j}.

In particular, to calculate the output values of the neural network 2000, the input values are propagated through the neural network. In particular, the values of the nodes 2020, . . . , 2032 of the (n+1)-th layer 2010, . . . , 2013 can be calculated based on the values of the nodes 2020, . . . , 2032 of the n-th layer 2010, . . . , 2013 by

xⱼ⁽ⁿ⁺¹⁾=f(Σᵢxᵢ⁽ⁿ⁾·w_{i,j}⁽ⁿ⁾)

Herein, the function f is a transfer function (another term is “activation function”). Known transfer functions are step functions, sigmoid function (e.g., the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 2010 are given by the input of the neural network 2000, wherein values of the first hidden layer 2011 can be calculated based on the values of the input layer 2010 of the neural network, wherein values of the second hidden layer 2012 can be calculated based in the values of the first hidden layer 2011, etc.

In order to set the values w^{(m,n)}_{i,j} for the edges, the neural network 2000 has to be trained using training data. In particular, training data comprises training input data and training output data (denoted as tᵢ). For a training step, the neural network 2000 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 2000 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δ⁽ⁿ⁾ⱼ can be recursively calculated as

δⱼ⁽ⁿ⁾=(Σₖδₖ⁽ⁿ⁺¹⁾·w_{j,k}⁽ⁿ⁺¹⁾)·f′(Σᵢxᵢ⁽ⁿ⁾·w_{i,j}⁽ⁿ⁾)

based on δ(n+1)j, if the (n+1)-th layer is not the output layer, and

δⱼ⁽ⁿ⁾=(xₖ⁽ⁿ⁺¹⁾−tⱼ⁽ⁿ⁺¹⁾)·f′(Σᵢxᵢ⁽ⁿ⁾·w_{i,j}⁽ⁿ⁾)

if the (n+1)-th layer is the output layer 2013, wherein f′ is the first derivative of the activation function, and y⁽ⁿ⁺¹⁾ⱼ is the comparison training value for the j-th node of the output layer 2013.

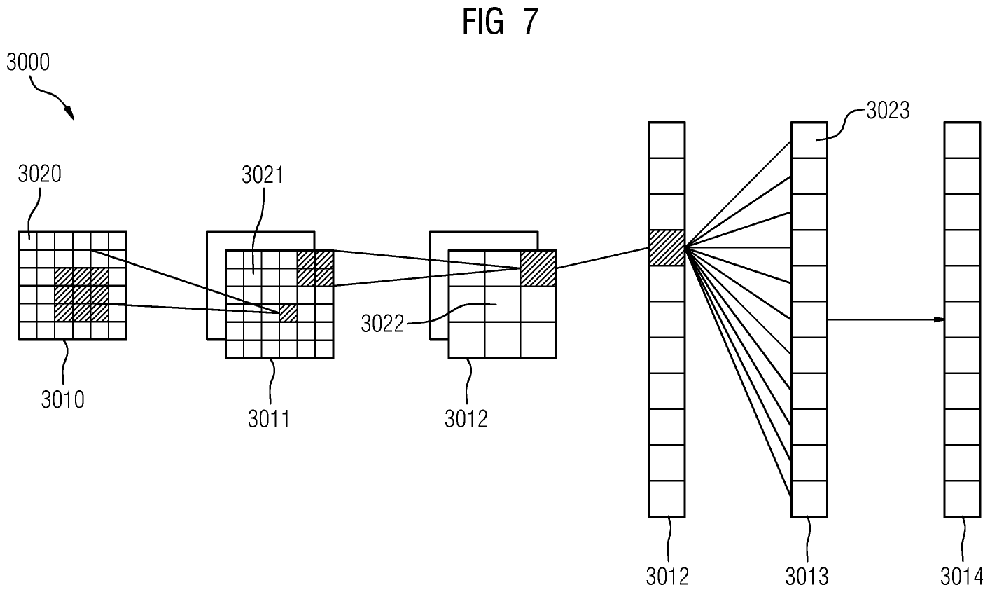

FIG. 7 displays an embodiment of a convolutional neural network 3000 which may be used in the context of providing an alarm relating to an accuracy of a trained function, in particular for detecting an accuracy decrease of a trained function under a distribution drift of incoming data.

In the displayed embodiment, the convolutional neural network comprises 3000 an input layer 3010, a convolutional layer 3011, a pooling layer 3012, a fully connected layer 3013 and an output layer 3014. Alternatively, the convolutional neural network 3000 can comprise several convolutional layers 3011, several pooling layers 3012 and several fully connected layers 3013, as well as other types of layers. The order of the layers can be chosen arbitrarily, usually fully connected layers 3013 are used as the last layers before the output layer 3014.

In particular, within a convolutional neural network 3000 the nodes 3020, . . . , 3024 of one layer 3010, . . . , 3014 can be considered to be arranged as a d-dimensional matrix or as a d-dimensional image. In particular, in the two-dimensional case the value of the node 3020, . . . , 3024 indexed with i and j in the n-th layer 3010, . . . , 3014 can be denoted as x⁽ⁿ⁾_{[i,j]}. However, the arrangement of the nodes 3020, . . . , 3024 of one layer 3010, . . . , 3014 does not have an effect on the calculations executed within the convolutional neural network 3000 as such, since these are given solely by the structure and the weights of the edges.

In particular, a convolutional layer 3011 is characterized by the structure and the weights of the incoming edges forming a convolution operation based on a certain number of kernels. In particular, the structure and the weights of the incoming edges are chosen such that the values x⁽ⁿ⁾ₖ of the nodes 3021 of the convolutional layer 3011 are calculated as a convolution x⁽ⁿ⁾ₖ=Kₖ*x⁽ⁿ⁻¹⁾ based on the values x⁽ⁿ⁻¹⁾ of the nodes 3020 of the preceding layer 3010, where the convolution * is defined in the two-dimensional case as

xₖ⁽ⁿ⁾[i,j]=(Kₖ*x⁽ⁿ⁻¹⁾)[i,j]=Σ_{i′}Σ_{j′}Kₖ[i′,j′]·x⁽ⁿ⁻¹⁾[i−i′,j−j′].

Here the k-th kernel Kₖ is a d-dimensional matrix (in this embodiment a two-dimensional matrix), which is usually small compared to the number of nodes 3020, . . . , 3024 (e.g., a 3×3 matrix, or a 5×5 matrix). In particular, this implies that the weights of the incoming edges are not independent but chosen such that they produce said convolution equation. In particular, for a kernel being a 3×3 matrix, there are only 9 independent weights (each entry of the kernel matrix corresponding to one independent weight), irrespectively of the number of nodes 3020, . . . , 3024 in the respective layer 3010, . . . , 3014. In particular, for a convolutional layer 3011 the number of nodes 3021 in the convolutional layer is equivalent to the number of nodes 3020 in the preceding layer 3010 multiplied with the number of kernels.

If the nodes 3020 of the preceding layer 3010 are arranged as a d-dimensional matrix, using a plurality of kernels can be interpreted as adding a further dimension (denoted as “depth” dimension), so that the nodes 3021 of the convolutional layer 3021 are arranged as a (d+1)-dimensional matrix. If the nodes 3020 of the preceding layer 3010 are already arranged as a (d+1)-dimensional matrix comprising a depth dimension, using a plurality of kernels can be interpreted as expanding along the depth dimension, so that the nodes 3021 of the convolutional layer 3021 are arranged also as a (d+1)-dimensional matrix, wherein the size of the (d+1)-dimensional matrix with respect to the depth dimension is by a factor of the number of kernels larger than in the preceding layer 3010.

The advantage of using convolutional layers 3011 is that spatially local correlation of the input data can exploited by enforcing a local connectivity pattern between nodes of adjacent layers, in particular by each node being connected to only a small region of the nodes of the preceding layer.

In the displayed embodiment, the input layer 3010 comprises 36 nodes 3020, arranged as a two-dimensional 6×6 matrix. The convolutional layer 3011 comprises 72 nodes 3021, arranged as two two-dimensional 6×6 matrices, each of the two matrices being the result of a convolution of the values of the input layer with a kernel. Equivalently, the nodes 3021 of the convolutional layer 3011 can be interpreted as arranges as a three-dimensional 6×6×2 matrix, wherein the last dimension is the depth dimension.

A pooling layer 3012 can be characterized by the structure and the weights of the incoming edges and the activation function of its nodes 3022 forming a pooling operation based on a non-linear pooling function f. For example, in the two-dimensional case the values x⁽ⁿ⁾ of the nodes 3022 of the pooling layer 3012 can be calculated based on the values x⁽ⁿ⁻¹⁾ of the nodes 3021 of the preceding layer 3011 as

x⁽ⁿ⁾[i,j]=f(x⁽ⁿ⁻¹⁾[id₁,jd₂], . . . ,x⁽ⁿ⁻¹⁾[id₁+d₁−1,jd₂+d₂−1])

In other words, by using a pooling layer 3012 the number of nodes 3021, 3022 can be reduced, by replacing a number d1·d2 of neighboring nodes 3021 in the preceding layer 3011 with a single node 3022 being calculated as a function of the values of said number of neighboring nodes in the pooling layer. In particular, the pooling function f can be the max-function, the average or the L2-Norm. In particular, for a pooling layer 3012 the weights of the incoming edges are fixed and are not modified by training.

The advantage of using a pooling layer 3012 is that the number of nodes 3021, 3022 and the number of parameters is reduced. This leads to the amount of computation in the network being reduced and to a control of overfitting.

In the displayed embodiment, the pooling layer 3012 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully connected layer 3013 can be characterized by the fact that a majority, in particular, all edges between nodes 3022 of the previous layer 3012 and the nodes 3023 of the fully connected layer 3013 are present, and wherein the weight of each of the edges can be adjusted individually.

In this embodiment, the nodes 3022 of the preceding layer 3012 of the fully connected layer 3013 are displayed both as two-dimensional matrices, and additionally as non-related nodes (indicated as a line of nodes, wherein the number of nodes was reduced for a better presentability). In this embodiment, the number of nodes 3023 in the fully connected layer 3013 is equal to the number of nodes 3022 in the preceding layer 3012. Alternatively, the number of nodes 3022, 3023 can differ.

Furthermore, in this embodiment the values of the nodes 3024 of the output layer 3014 are determined by applying the Softmax function onto the values of the nodes 3023 of the preceding layer 3013. By applying the Softmax function, the sum of the values of all nodes 3024 of the output layer is 1, and all values of all nodes 3024 of the output layer are real numbers between 0 and 1. In particular, if using the convolutional neural network 3000 for categorizing input data, the values of the output layer can be interpreted as the probability of the input data falling into one of the different categories.

A convolutional neural network 3000 can also comprise a ReLU (acronym for “rectified linear units”) layer. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer. Examples for rectifying functions are f(x)=max(0,x), the tangent hyperbolics function or the sigmoid function.

In particular, convolutional neural networks 3000 can be trained based on the backpropagation algorithm. For preventing overfitting, methods of regularization can be used, e.g., dropout of nodes 3020, . . . , 3024, stochastic pooling, use of artificial data, weight decay based on the L1 or the L2 norm, or max norm constraints.

It is important to note that while the disclosure comprises a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or data bearing medium or storage medium utilized to actually carry out the distribution. Examples of non-transitory machine usable/readable or computer usable/readable mediums comprise: ROMs, EPROMs, magnetic tape, floppy disks, hard disk drives, SSDs, flash memory, CDs, DVDs, and Blu-ray disks. The computer-executable instructions may comprise a routine, a sub-routine, programs, applications, modules, libraries, a thread of execution, and/or the like. Still further, results of acts of the methodologies may be stored in a computer-readable medium, displayed on a display device, and/or the like.

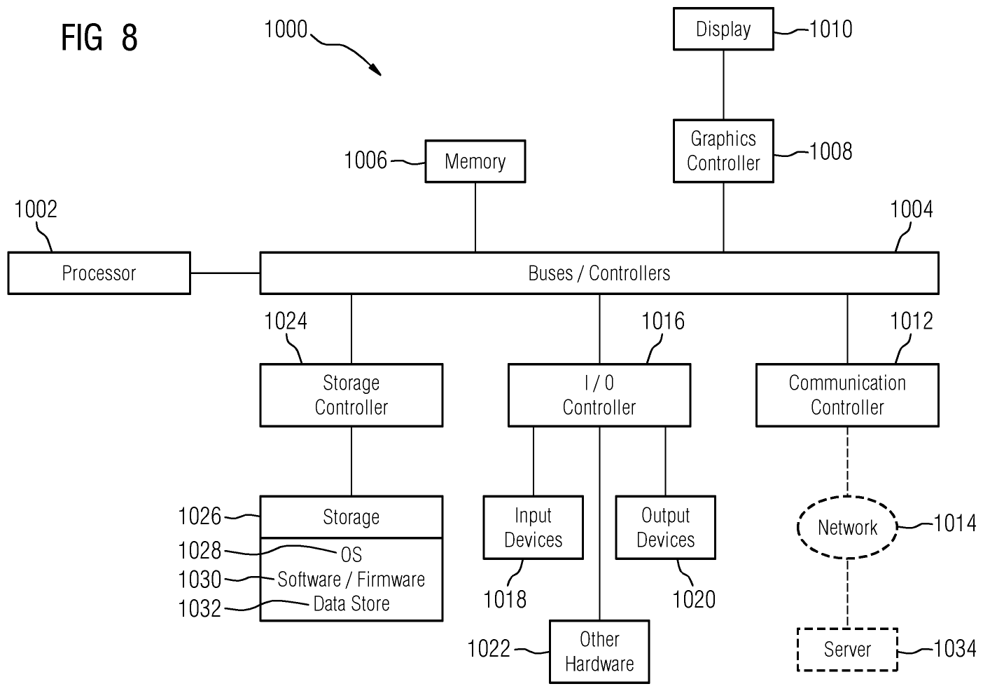

FIG. 8 illustrates a block diagram of a data processing system 1000 (also referred to as a computer system) in which an embodiment can be implemented, for example, as a portion of a product system, and/or other system operatively configured by software or otherwise to perform the processes as described herein. The data processing system 1000 may comprise, for example, the computer or IT system or data processing system 100 mentioned above. The data processing system depicted comprises at least one processor 1002 (e.g., a CPU) that may be connected to one or more bridges/controllers/buses 1004 (e.g., a north bridge, a south bridge). One of the buses 1004, for example, may comprise one or more I/O buses such as a PCI Express bus. Also connected to various buses in the depicted example may comprise a main memory 1006 (RAM) and a graphics controller 1008. The graphics controller 1008 may be connected to one or more display devices 1010. It should also be noted that in some embodiments one or more controllers (e.g., graphics, south bridge) may be integrated with the CPU (on the same chip or die). Examples of CPU architectures comprise IA-32, x86-64, and ARM processor architectures.

Other peripherals connected to one or more buses may comprise communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may comprise one or more I/O controllers 1016 such as USB controllers, Bluetooth controllers, and/or dedicated audio controllers (connected to speakers and/or microphones). It should also be appreciated that various peripherals may be connected to the I/O controller(s) (via various ports and connections) comprising input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, it should be appreciated that many devices referred to as input devices or output devices may both provide inputs and receive outputs of communications with the data processing system. For example, the processor 1002 may be integrated into a housing (such as a tablet) that comprises a touch screen that serves as both an input and display device. Further, it should be appreciated that some input devices (such as a laptop) may comprise a plurality of different types of input devices (e.g., touch screen, touch pad, keyboard). Also, it should be appreciated that other peripheral hardware 1022 connected to the I/O controllers 1016 may comprise any type of device, machine, or component that is configured to communicate with a data processing system.

Additional components connected to various busses may comprise one or more storage controllers 1024 (e.g., SATA). A storage controller may be connected to a storage device 1026 such as one or more storage drives and/or any associated removable media, which can be any suitable non-transitory machine usable or machine-readable storage medium. Examples comprise nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may comprise an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may comprise Microsoft Windows, Linux, UNIX, iOS, and Android operating systems. Also, examples of data stores comprise data files, data tables, relational database (e.g., Oracle, Microsoft SQL Server), database servers, or any other structure and/or device that is capable of storing data, which is retrievable by a processor.

The communication controllers 1012 may be connected to the network 1014 (not a part of data processing system 1000), which can be any public or private data processing system network or combination of networks, as known to those of skill in the art, comprising the Internet. Data processing system 1000 can communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely.

In addition, it should be appreciated that data processing systems may be implemented as virtual machines in a virtual machine architecture or cloud environment. For example, the processor 1002 and associated components may correspond to a virtual machine executing in a virtual machine environment of one or more servers. Examples of virtual machine architectures comprise VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be comprised in a client device that communicates with the server (and/or a virtual machine executing on the server) through a wired or wireless network (which may comprise the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols comprise Teradici's PCoIP, Microsoft's RDP, and the RFB protocol. In such examples, the processor described herein may correspond to a virtual processor of a virtual machine executing in a physical processor of the server. As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, it should be understood that the words or phrases used herein should be construed broadly, unless expressly limited in some examples. For example, the terms “comprise” and “comprise,” as well as derivatives thereof, mean inclusion without limitation. The singular forms “a”, “an” and “the” are intended to comprise the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to comprise, be comprised within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean: that an element is relatively near to but not in contact with a further element; or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present patent document should be read as implying that any particular element, step, act, or function is an essential element, which must be comprised in the claim scope: the scope of patented subject matter is defined only by the allowed claims.

1. Computer-implemented method comprising:
receiving input data messages (140) relating to at least one variable of at least one device (142);
applying a trained function (120) to the input data messages (140) to generate output data (152), the output data (152) being suitable for analyzing, monitoring, operating and/or controlling the respective device (142);
determining at least one respective distance of the respective variable of a respective received input data message (140) to a reference data set,
determining an accuracy value of the trained function (120) using the respective distance and a regression model (130),
wherein the respective distance is used as input for the regression model (130), and wherein the regression model (130) links the respective distance with the corresponding accuracy value,
wherein the respective variable is a multi-dimensional variable, the respective distance is a respective multi-dimensional distance, the reference data set is a multi-dimensional reference data set, and the trained function (120) is a multi-dimensional trained function (120); and
if the determined accuracy value is smaller than an accuracy threshold:
providing an alarm (150) relating to the determined accuracy value to a user, to the respective device (142) and/or an IT system connected to the respective device (142).

2. Computer-implemented method according to claim 1, wherein the input data messages (140) undergo a distribution drift involving a decrease of the accuracy value of the trained function (120).

3. Computer-implemented method according to claim 1 or 2, further comprising:
manipulating the respective distance by one of scaling, bootstrapping, norming or any combination thereof.

4. Computer-implemented method according to any of the preceding claims, wherein the regression model (130) is a trained regression model, the method further comprising:
providing a regression training data set comprising raw data and drifted raw data;
determining a respective distance vector x and a respective accuracy value y using the regression training data set; and
training the regression model x→y to obtain the trained regression model using the regression training data set.

5. Computer-implemented method according to any of the preceding claims, further comprising, if the determined accuracy value is equal to or greater than the accuracy threshold:
embedding the trained function (120) in a software application for analyzing, monitoring, operating and/or controlling the at least one device (142); and
deploying the software application on the at least one device (142) or an IT system connected to the at least one device (142) such that the software application may be used for analyzing, monitoring, operating and/or controlling the at least one device (142).

6. Computer-implemented method according to claim 5, further comprising, if the determined accuracy value is smaller than the accuracy threshold or a higher, first accuracy threshold:
amending the trained function (120) such that a determined amended accuracy value of the amended trained function (120) for the respective distance using the regression model (130) is greater than the accuracy threshold;
replacing the trained function (120) with the amended trained function (120) in the software application to obtain an amended software application; and
deploying the amended software application on the at least one device (142) or the IT system.

7. Computer-implemented method according to claim 6, further comprising:
using a plurality of received input data messages (140) as a training data set, wherein the plurality of received input data messages (140) are characterized by a distribution drift involving a decrease of the accuracy value of the trained function (120);
training the trained function (120) with the training data set to obtain the amended trained function.

8. Computer-implemented method according to any of claims 5 to 7, further comprising, if the amendment of the trained function (120) takes more time than a duration threshold:
replacing the deployed software application with a backup software application; and
analyzing, monitoring, operating and/or controlling the at least one device (142) using the backup software application.

9. Computer-implemented method according to any of the preceding claims, further comprising for a plurality of interconnected devices (142):
embedding a respective trained function (120) in a respective software application for analyzing, monitoring, operating and/or controlling the respective interconnected device(s) (142);
deploying the respective software application on the respective interconnected device(s) (142) or an IT system connected to the plurality of interconnected devices (142) such that the respective software application may be used for analyzing, monitoring, operating and/or controlling the respective interconnected device(s) (142);
determining a respective accuracy value of the respective trained function (120); and
if the respective, determined accuracy value is smaller than a respective accuracy threshold:
providing an alarm (150) relating to the respective, determined accuracy value and the respective interconnected device(s) (142) for which the corresponding respective software application is used for analyzing, monitoring, operating and/or controlling the respective interconnected device(s) (142) to a user, to the respective device(s) (142) and/or an IT system connected to the respective device(s) (142).

10. Computer-implemented method according to any of the preceding claims,
wherein the respective device (142) is any one of a production machine, an automation device, a sensor, a production monitoring device, a vehicle or any combination thereof.

11. A system (100), in particular an IT system, comprising
a first interface (170), configured for receiving input data messages (140) relating to at least one variable of at least one device (142);
a computation unit (124), configured for
applying a trained function (120) to the input data messages (140) to generate output data (152), the output data (152) being suitable for analyzing, monitoring, operating and/or controlling the respective device (142);
determining at least one respective distance of the respective variable of a respective received input data message (140) to a reference data set,
determining an accuracy value of the trained function (120) using the respective distance and regression model (130),
wherein the respective distance is used as input for the regression model (130), and wherein the regression model (130) links the respective distance with the corresponding accuracy value, wherein the respective variable is a multi-dimensional variable, the respective distance is a respective multi-dimensional distance, the reference data set is a multi-dimensional reference data set, and the trained function (120) is a multi-dimensional trained function (120); and
a second interface (172), configured for providing an alarm (150) relating to the determined accuracy value to a user, to the respective device (142) and/or an IT system connected to the respective device (142), if the determined accuracy value is smaller than an accuracy threshold.

12. A computer program product, comprising computer program code which, when executed by a system (100), in particular an IT system, cause the system (100) to carry out the method of one of the claims 1 to 10.

13. A computer-readable medium comprising computer program code which, when executed by a system (100), in particular an IT system, cause the system (100) to carry out the method of one of the claims 1 to 10.
